(19) United States
(12) Patent Application Publication
(10) Pub. No.: US 2009/0304995 A1
(43) Pub. Date: Dec. 10, 2009

(54) HYDROPHILIC FLUOROPOLYMER MATERIALS AND METHODS

(75) Inventor: Kurt Karl Christenson, Minnetonka, MN (US)

Correspondence Address: KAGAN BINDER, PLLC, SUITE 200, MAPLE ISLAND BUILDING, 221 MAIN STREET NORTH, STILLWATER, MN, 55082, US

(73) Assignee: FSI INTERNATIONAL, INC., Chaska, MN (US)

(21) Appl. No.: 12/478,141

(22) Filed: Jun. 4, 2009

Related U.S. Application Data
(60) Provisional application No. 61/131,411, filed on Jun. 9, 2008.

(51) Int. Cl. B32B 3/26; B24B 1/00; B24C 1/00; B44C 1/22

(52) U.S. Cl. 428/141; 451/28; 451/38; 216/83

(57) ABSTRACT

An initially hydrophobic surface comprising fluoropolymer is treated to provide the surface with hydrophilic properties. A hydrophobic surface comprising fluoropolymer is physically treated to impart a rough texture thereto, thereby providing the surface with hydrophilic properties. In an alternative method, a roughened surface is treated with a sulfur-based acid, thereby providing the surface with hydrophilic properties

In yet another method, a non-roughened surface fluoropolymer surface is treated with a sulfur-based acid for a time sufficient for the surface to exhibit hydrophilic properties. Products made by these processes are also described.

This application claims the benefit of U.S. Provisional Application Ser. No. 61/131,411 filed on Jun. 9, 2008, entitled “HYDROPHILIC FLUOROPOLYMER MATERIALS AND METHODS,” which application is incorporated herein by reference in its entirety.

### FIELD OF THE INVENTION

The present invention relates to hydrophilic fluoropolymers and methods for preparation. More specifically, the present invention relates to treatment of fluoropolymers to provide a surface that exhibits hydrophilic properties.

### BACKGROUND OF THE INVENTION

Preparation of articles by chemical treatment processes in precision manufacturing techniques has become increasingly more and more difficult, because the articles and features of the articles are being manufactured in smaller and smaller sizes. For example, very small features (e.g. at submicron size) include layers and structure in the article, that are created by chemical treatment and etching processes. Providing tool surfaces that are resistant to chemical attack and also that are readily cleaned and/or dried is a challenge.

Treatment vessels and operational parts within such vessels in particular are often exposed to chemically aggressive materials, and may be used in processes that use a sequence of chemicals that must be effectively removed during the process. Additionally, liquids in the form of collected beads are more difficult to remove from surfaces than sheeted liquid (i.e. liquids that are wetted out over a surface) because drying time is longer for beaded liquids. A stray drop of liquid that might fall on a precision manufactured article as discussed above can have an extremely adverse affect on the performance of the article.

Fluoropolymers such as polytetrafluoroethylene and polyvinylidene fluoride are frequently used in the manufacture of tools for carrying out precision chemical treatment processes, in part because of their highly chemical resistant nature. Such polymers are generally hydrophobic. As noted above, the very hydrophobicity of this material can hinder rinsing and drying as many liquids, including water, form stationary beads instead of forming a sheet that can flow off the part. Other materials, such as poly(p-phenylene sulfide (“PPS”), have excellent mechanical characteristics, but their purity and chemical resistance are inadequate for use as a wetted part in a semiconductor processing system.

In certain applications, molded articles manufactured from polytetrafluoroethylene or modified polytetrafluoroethylene have been found to be useful as chemical containers and transport pipes in the rigorously clean environment of the semiconductor industry. See U.S. Pat. No. 6,673,416 to Nishio, which describes coating such articles with a heat-flowable tetrafluoroethylene copolymer coating so that the surface of the coated article has a reduced roughness compared to the molded article prior to coating.

Fluoropolymers have in the past been chemically functionalized. For example, U.S. Pat. No. 7,160,928 to Hamrock, et. al. describe methods to make acid functional fluoropolymers by: a) dehydrofluorinating a starting fluoropolymer with a dehydrofluorinating agent to form an unsaturated fluoropolymer; b) adding an acidifiable nucleophilic functionalizing agent to a double bond of the unsaturated fluoropolymer; and c) acidifying the added acidifiable function. The described method is used in particular for fabrication of ion conducting membranes (ICMs). Hamrock, et al. state at column 5, lines 37-47 that “[t]he starting fluoropolymer may be formed into a membrane by any suitable means, including casting, coating, pressing, extruding, and the like, but most preferably coating. Membrane formation may be carried out prior to addition of the acidifiable function, after addition of the acidifiable function but prior to acidification, or after acidification. Preferably, the polymer is formed into a membrane after functionalization but prior to acidification. Most preferably, the acidifiable function is added to the polymer in solution, the polymer is then cast or coated to form a membrane, and then the membrane is acidified.”

A simple method for modifying fluoropolymer surfaces for use, for example, in treatment vessels and operational parts to render the surface hydrophilic would be very desirable.

### SUMMARY OF THE INVENTION

The present invention provides a method for treating an initially hydrophobic surface comprising fluoropolymer to provide the surface with hydrophilic properties. Products made using this unique material exhibiting hydrophilic properties benefit from the protection afforded by the generally inert nature of the fluoropolymer in combination with the surface behavior of hydrophilicity.

In one embodiment, a hydrophobic surface comprising fluoropolymer is physically treated to impart a rough texture thereto. In another embodiment, the roughened hydrophobic surface comprising fluoropolymer is exposed to a sulfur-based acid to provide the surface with hydrophilic properties. In an embodiment, the sulfur-based acid is selected from sulfuric acid, sulfonic acid, and derivatives or precursors thereof. Examples of sulfuric acid derivatives and precursors include sulfur trioxide (SO₃), thiosulfuric acid (H₂S₂O₃), peroxosulfuric acid (H₂SO₅), peroxydisulfuric acid (H₂S₂O₈), fluorosulfuric acid (HSO₃F), and chlorosulfuric acid (HSO₃Cl))

In yet another method, a non-roughened surface fluoropolymer is exposed to a sulfur-based acid for a time sufficient for the surface to exhibit hydrophilic properties.

Products made by these processes and systems incorporating these products are also described.

The present invention is particularly advantageous for preparing surfaces and articles used in precision manufacturing processes, whereby it is desirable to provide chemically inert or chemically resistant materials that have surfaces that are wetted by aqueous liquids. A particularly advantageous system incorporating the products described herein are semiconductor material processing tools, and in particular semiconductor wafer processing tools. Wettable surfaces are particularly advantageous because they tend to dry faster due to evaporative effects. Additionally such surfaces tend not to form aqueous liquid drops that are either slow to dry or may drop on otherwise clean surfaces, thereby contaminating the surface and affecting product performance.

The present invention beneficially uses readily available chemicals. The process can be carried out on any geometry of part, providing a surface that affords unique performance benefits.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 shows a prior art side view of a liquid beading up on a surface with a contact angle near 90°.

FIG. 2 shows a side view of the same liquid “wetting” a roughened surface.

FIG. 3 is a graph showing contact angles of substrates having been exposed to different treatment protocols.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

In the present invention, an initially hydrophobic surface comprising fluoropolymer is treated to provide the surface with hydrophilic properties. The hydrophobic surface comprising fluoropolymer may be an article that is made from a homogenous material that contains fluoropolymer. Alternatively, the initially hydrophobic surface may be a surface coating that contains fluoropolymer on a substrate article that may or may not contain fluoropolymer.

The fluoropolymer of the surface may be selected from any fluoropolymer susceptible to formation of hydrophilic surface by exposure to fuming sulfuric acid after physical roughening. In a preferred embodiment of the present invention, the fluoropolymer has hydrogen and fluorine substituents on adjacent carbons. These >CH—CF<moieties preferably occur in the polymer backbone, but may also occur in pendant groups or branches. Preferably the starting fluoropolymer is between 5% and 95% fluorinated, i.e. between 5% and 95% of C—H bonds are replaced with C—F bonds. More preferably the starting fluoropolymer is between 30% and 70% fluorinated and most preferably 45 and 55%. The starting fluoropolymer may be additionally substituted but is preferably not additionally substituted.

Preferably, the fluoropolymer is a polymer or copolymer of vinylidene fluoride (1,1-difluoroethene). In a preferred embodiment, the fluoropolymer is PVDF (polyvinylidene fluoride). In another embodiment, the fluoropolymer is a copolymer of vinylidene fluoride and at least one other monomer, preferably a fluorine-containing monomer. In another embodiment, the fluoropolymer is a copolymer of ethylene and tetrafluoroethylene, or ETFE (polyethylenetetrafluoroethylene). In another embodiment, the fluoropolymer is a copolymer of ethylene-chlorotrifluoroethylene, or ECTFE (Polyethylenechlorotrifluoroethylene). In another embodiment, the fluoropolymer is THV, which is a terpolymer of tetrafluoroethylene, hexafluoropropylene and vinylidene fluoride. In another embodiment, the fluoropolymer is a copolymer of a fluoro-functional monomer with polyethylene (PE).

Preferably, the fluoropolymer is selected from melt-processable polymers. Such polymers are particularly advantageous because they can be formed in any configuration. This material, in combination with the present method, is advantageous because the present treatment method can be adapted to treat surfaces having any configuration. Thus, devices can be constructed that exhibit hydrophilic properties and having the additional performance benefits as described herein.

In an embodiment of the present invention, the surface to be treated is a component part that is assembled with other components of a tool, and the component part is in the final form or configuration required for use. In this embodiment, the component part may be treated as a whole, or only the surfaces of the component part that is expected to be exposed in final use (i.e. which are desired to be hydrophilic in the final part) are treated. The part and surfaces thereof may be prepared by molding operation or by use of machining manufacturing techniques. Alternatively, the surfaces can be prepared as a cast polymer film, a polymer coating applied to a part, or other means of producing an exposed polymer surface.

For purposes of the present invention, a surface has a rough texture if it contains vertical deviations from its surface in an amount sufficient to lower the measured receding contact angle of DI water on the surface as compared to a like surface that does not have a rough texture.

In an embodiment of the present invention, the surface roughness can be measured by an instrument, with results preferably expressed as Ra, which is the arithmetic average deviation from the center line of the surface. Ra can be measured in any appropriate manner, such as by traversing a stylus across the specimen and recording the vertical movement thereof. The thus recorded peaks and valleys are converted into the Ra value. See ASME B46.1-2002 © 2003 The American Society of Mechanical Engineers, Three Park Avenue, NY, N.Y., 10016-5990, pp. 1-4, the disclosure of which is incorporated by reference herein. In certain embodiments of the present invention, the use of a physical stylus for measuring roughness may be difficult because the material that is treated is soft, or the features of the surface are too small for readily available stylus measurement tools. Alternative measurement techniques, such as use of SEM and/or TEM may be utilized as will be appreciated by the skilled artisan.

In an embodiment of the present invention, the treated article has a centerline Ra (i.e. arithmetic average roughness) of greater than about 5 micrometers, more preferably greater than 50 micrometers, more preferably greater than 75 micrometers.

The rough surface texture can, in one embodiment, be quantified by evaluating the present surface roughness as a measure of increase in % surface roughness, as compared to the form of the surface prior to the physical treatment.

For purposes of the present invention, percent surface roughness surface is defined as:

[(Surface roughness treated article−surface roughness untreated article)/surface roughness untreated article)]×100

Preferably, the surface roughness is increased by at least 25%, more preferably by at least 50% and most preferably by at least 75% as compared to the form of the surface prior to the physical treatment.

For purposes of the present invention, profile peak is the point of maximum height on a portion of a profile that lies above the mean line and between two intersections of the profile with the mean line; and the profile valley is the point of minimum height on a portion of a profile that lies below the mean line and between two intersections of the profile with the mean line. A nominal surface is the intended surface boundary (exclusive of any intended surface roughness), the shape and extent of which is usually shown and dimensioned on a drawing or descriptive specification. A real surface is the actual boundary of an object. The deviations of a real surface from the nominal surface stem from the processes that produce the surface.

Preferably, the roughening process provides peaks and valleys where the peaks provide protection from mechanical contact to the bulk of the surface lying below the peaks. Such a surface is typically results from having the typical spacing between adjacent peaks be less than about 2 mm, and preferably less than about 0.5 mm, and that the ratio of peak spacing to peak-to-valley height be less than about 2, and preferably less than about 0.5. That is, closely spaced peaks surrounding deep valleys are preferred. Thus, in a preferred embodiment, the physically treating step provides peaks and valleys, wherein the average spacing between adjacent peaks is from about 2 mm to about 0.02 mm, and the ratio of peak spacing to peak-to-valley height is from about 2 to about 0.1.

Preferably, the average local angle of the real surface varies substantially from the mean plane of the nominal surface, reducing the effective contact angle of liquids on the surface. It is preferred that the average local angle is greater than 10 degrees, and more preferable that the angle is more than 30 degrees from the mean plane of the nominal surface.

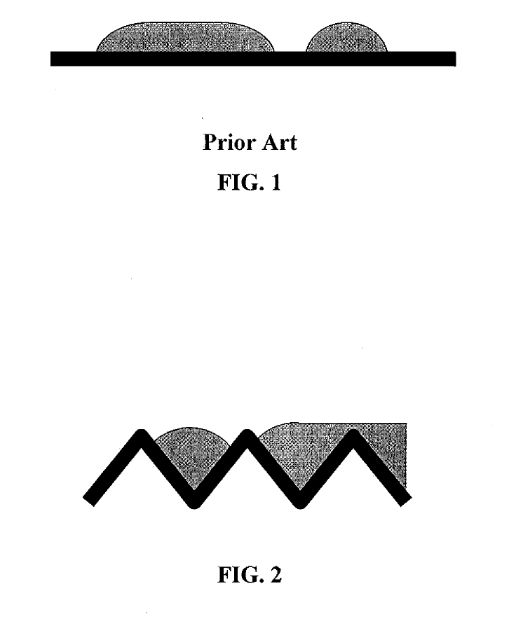

This variance of the local angle of the real surface of the plane of the nominal surface provides an effective contact angle that has profound effect on the behavior of liquids on the surfaces. FIG. 1 shows a prior art side view of a liquid beading up on a surface with a contact angle near 90°. It will be recognized that the water as shown will not flow from the surface easily, and additionally presents very little surface area to the atmosphere, and therefore is very slow to dry. FIG. 2 shows the same liquid “wetting” a roughened surface. The angularity of surface B allows wetting to be maintained despite the 90° contact angle. The liquid will tend to flow easier in this surface configuration, and additionally will present more surface area to the atmosphere, facilitating drying.

In an embodiment of the present method, the surface of the material is physically treated to impart a rough texture thereto. The mechanical roughening of the surface can be carried out by any process capable of producing a surface having a roughness to lower the measured receding contact angle of DI water on the surface as compared to a like surface that does not have a rough texture. Such a rough surface can be provided as part of a mold, so that the rough surface is present on an as-molded part. Alternatively, the rough surface may be impressed into the polymer surface.

In a particularly preferred embodiment, the rough surface is imparted by a process that applies disruptive physical energy to the surface, so that the surface is abruptly modified by tearing and the like. Such disruptive processes include machining, abrasion as by a wire brush or sand paper, or other means. A particularly preferred disruptive process is where the surface is roughened by grit blasting. While not being bound by theory, it is believed that the disruptive physical processes for providing a rough surface affect the fluoropolymer on a molecular scale, perhaps affecting chemical bonds within the fluoropolymer. The disruptive physical processes in particular are believed to render the fluoropolymer more susceptible to reaction or non-covalent bond interaction with hydrophilic functionalities, thereby efficiently providing the surface with hydrophilic properties.

In an embodiment of the present invention, a hydrophobic surface comprising fluoropolymer is physically treated to impart a rough texture thereto without subsequent treatment by a sulfur-based acid. Preferably in this embodiment, the surface is roughened sufficiently to lower the measured receding contact angle of DI water on the surface more than 25%, and more preferably more than 50% as compared to a like surface that does not have a rough texture.

In another embodiment of the present invention, after roughening, the surface is exposed to a sulfur-based acid, thereby providing the surface with hydrophilic properties. In an embodiment, the sulfur-based acid is selected from sulfuric acid, sulfonic acid, and derivatives or precursors thereof. Examples of sulfuric acid derivatives and precursors include sulfur trioxide (SO₃), thiosulfuric acid (H₂S₂O₃), peroxosulfuric acid (H₂SO₅), peroxydisulfuric acid (H₂S₂O₈), fluorosulfuric acid (HSO₃F), and chlorosulfuric acid (HSO₃Cl)). A particularly preferred embodiment comprises treatment with fuming sulfuric acid. It will be recognized that FSA, or Fuming Sulfuric Acid is formed by providing sulfuric acid (H₂SO₄) with dissolved sulfur trioxide gas (SO₃). Treatment compositions comprising a sulfur-based acid in combination with other materials are specifically contemplated for use in the present method.

It has been found that treatment of a non-roughened fluoropolymer surface with alternative chemistries, such as hydrochloric acid, hydrofluoric acid, tetramethyl ammonium hydroxide, nitric acid, ammonium hydroxide, and phosphoric acid, does not provide a substantial benefit in providing hydrophilic properties to the non-roughened surface. A roughened polymer surface may optionally be treated with such alternative chemistries, but it has been determined that such additional chemical treatment does not provide additional benefit in providing a surface with hydrophilic properties, and may even deleteriously affect the relative hydrophilicity of the roughened surface.

The roughened polymer surface is exposed to the sulfur-based acid for a time sufficient to render the surface hydrophilic, without adversely affecting the physical integrity of the polymer surface. Thus, if the roughened polymer surface is exposed to the sulfur-based acid for too long a time, physical degradation of the polymer surface occurs, and the surface will become at least somewhat fragile. A roughened polymer surface is considered to be over-exposed to sulfur-based acid if, under ordinary conditions of use of the resulting part, the surface sheds particles of material in a quantity that is unacceptable for that use. As an example, a treated surface should not shed material when wetted with a liquid.

In an embodiment of the present invention, the roughened polymer is immersed in sulfur-based acid for from about 10 minutes to about 72 hours. The appropriate time of exposure of the roughened polymer surface to any given treatment composition is temperature dependent. In an embodiment of the present invention, the roughened polymer is immersed in sulfur-based acid for from about 16 to about 24 hours at a temperature of from about 10° to about 30° C. This treatment protocol provides a convenient process that can be carried out overnight, and additionally provides safety and convenience advantages in not requiring that the sulfur-based acid be handled at high temperatures. In another embodiment of the present invention, the roughened polymer is immersed in sulfur-based acid for from about 1 minute to about 2 hours at a temperature of from about 40° to about 70° C. Less than one minute exposure time is contemplated under appropriate conditions. This embodiment provides a very rapid treatment that is particularly useful for rapid part production and/or for mass production of parts. In view of the present disclosure, the skilled artisan may now readily choose the time and temperature conditions required in the exposure of the roughened polymer to sulfur-based acid to achieve the desired hydrophilicity for their particular application by routine experimentation.

It will be noted that only the surface of the fluoropolymer structure will be made hydrophilic, with the depth of chemical interaction determined in part by the time and temperature conditions required in the exposure of the roughened polymer to sulfur-based acid. Preferably, the roughened polymer surface is exposed to sulfur-based acid for a time and at a temperature sufficient for the fluoropolymer to exhibit hydrophilic properties to a depth of about 10 micrometers from the real surface. Advantageously, the lower portion of the structure remains hydrophobic, which can afford greater protection to structures below the fluoropolymer-containing article.

In an embodiment of the present invention, a hydrophobic surface comprising fluoropolymer is physically treated to impart a rough texture thereto with subsequent treatment by a sulfur-based acid. Preferably in this embodiment, the surface is roughened and acid treated sufficiently to lower the measured advancing contact angle of DI water on the surface more than 25%, and more preferably more than 50% as compared to a like surface that does not have a rough texture and has not been treated with a sulfur-based acid. Additionally, preferably in this embodiment, the surface is roughened and acid treated sufficiently to lower the measured receding contact angle of DI water on the surface more than 25%, and more preferably more than 50% as compared to a like surface that does not have a rough texture and has not been treated with a sulfur-based acid. Preferably, the measured receding contact angle of DI water on the surface that has been roughened and acid treated is less than 15°, and more preferably less than 5°.

In another embodiment of the present invention, a non-roughened polymer is treated (e.g. by immersion) with a sulfur-based acid under conditions effective to lower the measured receding contact angle of DI water on the surface as compared to a like surface that has not been treated with a sulfur-based acid.

In a preferred embodiment of the present invention, a non-roughened polymer is immersed in FSA at a temperature of over about 50°, and preferably from about 60° to about 90° C. for a time sufficient for the fluoropolymer to exhibit hydrophilic properties. This embodiment is less advantageous, because geometry of the surface of the resulting article does not provide the beneficial variance of the local angle of the real surface from the plane of the nominal surface to provide an effective contact angle as discussed above. It has, however, been found that aggressive exposure of FSA to a non-roughened polymer surface provides hydrophilic benefit. For example, a non-roughened fluoropolymer surface exposed to FSA at 60° C. for two hours exhibits hydrophilic properties, but was physically damaged by the exposure alone so that the sample became fragile. The skilled artisan will now appreciate that appropriate times and temperatures of exposure can be readily identified by routine experimentation.

In an embodiment of the present invention, a hydrophobic surface comprising fluoropolymer is not physically treated to impart a rough texture thereto, but is treated with a sulfur-based acid. Preferably in this embodiment, the surface is acid treated sufficiently to lower the measured advancing contact angle of DI water on the surface more than 25%, as compared to a like surface that has not been treated with a sulfur-based acid. Additionally, preferably in this embodiment, the surface is acid treated sufficiently to lower the measured receding contact angle of DI water on the surface more than 25%, and more preferably more than 50% as compared to a like surface that has not been treated with a sulfur-based acid.

The hydrophilic surfaces of the present invention are specifically contemplated for use in surfaces to be wetted, and working parts in semiconductor treatment processes. The tools are preferably particularly designed for preparation of semiconductor wafers or similar substrates, whether raw, etched with any feature, coated, or integrated with conductor leads or traces as an integrated circuit device, lead frames, medical devices, disks and heads, flat panel displays, microelectronic masks, micromechanical devices, microoptical devices, and the like.

In particular, the present invention is useful in managing the surfaces of such tools, for example in treatment chamber walls, ceilings, a turntable or carousel surfaces, spray arms, conduits, nozzles and other surfaces.

In an embodiment of the present invention, a semiconductor wafer processing tool comprises one or more components having at least one surface provided with hydrophilic properties as described herein. In an embodiment of the present invention, the semiconductor wafer processing tool is a spray processing tool, such as the MERCURY® or ZETA® spray processors commercially available from FSI International, Inc., Chaska, Minn., or the Magellan® system, also commercially available from FSI International, Chaska, Minn. In another embodiment, the semiconductor wafer processing tool is a single wafer processing tool. In an embodiment of the present invention, the tool is configured to treat the wafers in a substantially stationary position. In tools, uniform application and removal of aqueous treatment liquids to various surfaces is important to avoid inadvertent contact of the wafer to the liquid, which can lead to contamination of workpiece materials.

In particular, surfaces that drain liquids by gravity flow benefit from the present invention. Additionally, the present invention is particularly advantageous for use in component parts, such as spray posts, spinning chucks, wafer carriers, mechanical arms, tubing and the like.

### EXAMPLES

Representative embodiments of the present invention will now be described with reference to the following examples that illustrate the principles and practice of the present invention. Unless otherwise noted, all chemicals and reagents were obtained or are available from Aldrich Chemical Co., Milwaukee, Wis.

### Example 1

Hydrophilic fluoropolymer surfaces according to the present invention were made and tested along with comparative surfaces, as described in the text following.

### Procedure:

1×1″ samples were cut from compression molded SOLEF 6010 PVDF. The as-molded surfaces were grit blasted with two lots of crushed quartz from Powder Technology Incorporated, Burnsville, Minn. Quartz lot 90376 N was relatively coarse, with 4% of the grains larger than 600 um, 20.1%>400 um, 11.1%>300 um, 26.9%>200 um, 26.3%>150 um and 10.9%<150 um. Quartz lot 90376BF was finer, with 17% of the grains larger than 200 um, and 99.2%>53 um. The grit was dispensed from a Maxus MXS40001AV blaster gun with a 3/16″ inner diameter tip (Maxus Tools, Harrison Ohio). Tests were made with gun operating pressures of 60 or 90 psi, a tip to sample distance ranging from 1-6″ and a dwell time of 1-20 sec/in̂2.

After grit blasting, samples were soaked in 49 wt % HF for 12-24 hours at ambient temperature to dissolve any imbedded quartz particles.

Samples were then soaked in FSA for 16-24 hours at ambient temperature to create the hydrophilic surface.

TABLE 1

| | | | | | Dwell | |
|---|---|---|---|---|---|---|
| | | | Distance | Pressure | Time | |
| No. | Polymer | Grit | (inches) | (psi) | (sec/in²) | Results |
| 1 | PTFE | 90376 N | 1.5 | 90 | 5 | Very |
| | | | | | | Hydrophobic |
| 2 | PTFE | 90376 N | 1.5 | 90 | 20 | Very |
| | | | | | | Hydrophobic |
| 3 | PVDF | 90376 N | 1.5 | 90 | 5 | Hydrophilic |
| 4 | PVDF | 90376 N | 3 | 90 | 5 | Hydrophilic |
| 5 | PVDF | 90376 N | 6 | 90 | 5 | Hydrophilic |
| 6 | PVDF | 90376BF | 6 | 90 | 2 | Hydrophilic |
| 7 | PVDF | 90376BF | 6 | 90 | 1 | Hydrophilic |
| 8 | PVDF | 90376BF | 1.5 | 90 | 1 | Hydrophilic |
| 9 | PVDF | 90376BF | 3 | 90 | 1 | Hydrophilic |
| 10 | PVDF | 90376BF | 6 | 90 | 1 | Hydrophilic |
| 11 | PVDF | 90376BF | 6 | 90 | 5 | Hydrophilic |
| 12 | PVDF | 90376BF | 1.5 | 60 | 1 | Hydrophilic |
| 13 | PVDF | 90376BF | 3 | 60 | 1 | Hydrophilic |
| 14 | PVDF | 90376BF | 6 | 60 | 1 | Hydrophilic |
| 15 | PVDF | 90376BF | 6 | 60 | 5 | Hydrophilic |

### Example 2

A ¼″ thick sheet of compression molded PVDF was cut into 1×1″ samples for chemical testing. One side of each sample was roughened by grit blasting with a crushed quartz abrasive as described above.

The one-side roughened samples were then pre-cleaned using acetone in an ultrasonic bath for five minutes to remove organics and gross particulates. The samples were then immersed in ambient temperature 49% HF to dissolve any residual quartz.

A selection of the samples were then immersed for 16 hours at ambient temperature in either 20 wt % SO3 in H₂SO₄ (20% Oleum) or Chlorosulfonic acid (CSA). After immersion, the samples were rinsed and dried with N₂.

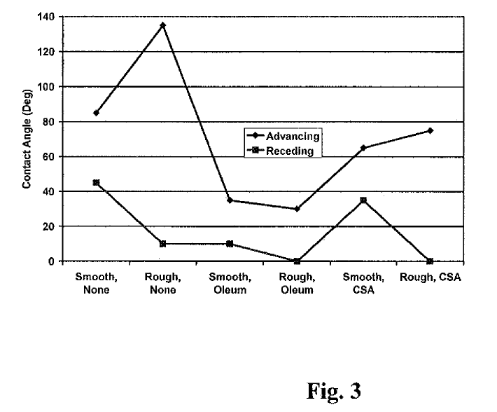

The advancing and receding contact angles of DI water on the samples were measured using a goniometer. The advancing contact angle indicates the angle of incidence of the water on the PVDF at the edge of an expanding water drop as measured from parallel to the surface. High angles indicate a resistance to wetting and a difficulty in having the water spread out across the surface. The receding contact angle was measured with a shrinking drop of water and corresponds to the performance during the drying process. Table 2 shows the numerical results of the measurements with the data shown graphically in FIG. 3.

TABLE 2

| | | | Contact Angle | |
|---|---|---|---|---|
| Sample | Roughened | Treatment | Advancing | Receding |
| Back | No | None | 85° | 45° |
| Front | Yes | None | 135° | 10° |
| Back | No | 20% Oleum | 35° | 10° |
| Front | Yes | 20% Oleum | 30° | 0°* |
| Back | No | CSA | 65° | 35° |
| Front | Yes | CSA | 75° | 0°* |

*A thin film of water remained after the bulk of the water was removed. The film appeared rough, with the low portions of the surface submerged and high portions protruding up.

As shown in FIG. 3, roughening alone (no chemical treatment) is actually detrimental to the wetting performance of the surface, while showing some benefit to the drying performance. In contrast, both the smooth, and especially the rough, CSA treated surface showed improvement over the untreated surface for both advancing and receding liquid interfaces. Likewise, the smooth oleum treated surface showed significantly better performance than the untreated smooth surface. By far the best performance, however, is achieved by the combination of roughening and treatment with oleum. In particular, the receding contact angle on the rough, CSA or oleum treated surfaces is zero. The water does not bead up at any point, but rather forms a thin film that evaporates to dryness

All patents, patent applications (including provisional applications), and publications cited herein are incorporated by reference as if individually incorporated for all purposes. Unless otherwise indicated, all pails and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method of treating an initially hydrophobic surface comprising fluoropolymer to provide the surface with hydrophilic properties comprises:
a) providing a hydrophobic surface comprising fluoropolymer; and
b) physically treating the surface to impart a rough texture thereto, thereby providing the surface with hydrophilic properties.

2. The method of claim 1, additionally comprising:
c) exposing the roughened surface to a sulfur-based acid, thereby providing the surface with hydrophilic properties.

3. The method of claim 1, wherein the surface having a rough texture has a surface roughness that is increased by at least 25% as compared to the form of the surface prior to the physical treatment.

4. The method of claim 1, wherein surface having a rough texture has a centerline Ra of greater than about 5 micrometers.

5. The method of claim 1, wherein the physically treating step is a process that applies disruptive physical energy to the surface.

6. The method of claim 1, wherein the physically treating step is selected from machining and abrasion.

7. The method of claim 1, wherein the physically treating step is by grit blasting.

8. The method of claim 1, wherein the physically treating step provides peaks and valleys, wherein the average spacing between adjacent peaks is from about 2 mm to about 0.02 mm, and the ratio of peak spacing to peak-to-valley height is from about 2 to about 0.1.

9. The method of claim 1, wherein the physically treating step provides real surfaces that vary from the mean plane of the nominal surface, so that the average local angle is greater than 10 degrees from the mean plane of the nominal surface.

10. The method of claim 1, wherein the surface exhibits hydrophilic properties to a depth of about 10 micrometers.

11. The method of claim 1, wherein the method is conducted on an article made from a homogenous material content fluoropolymer.

12. The method of claim 1, wherein the method is conducted on an article having a fluoropolymer coating.

13. The method of claim 2, wherein the sulfur-based acid is selected from sulfuric acid, sulfonic acid, and derivatives or precursors thereof.

14. The method of claim 2, wherein the sulfur-based acid is selected from fuming sulfuric acid and chlorosulfonic acid.

15. A method of treating an initially hydrophobic surface comprising fluoropolymer to provide the surface with hydrophilic properties comprises:
a) providing a non-roughened hydrophobic surface comprising fluoropolymer;
b) exposing the non-roughened surface to a sulfur-based acid at a temperature of over about 50° for a time sufficient for the surface to exhibit hydrophilic properties.

16. The method of claim 15, wherein the exposure to a sulfur-based acid is conducted at a temperature of from about 60° to about 90° C.

17. The method of claim 15, wherein the sulfur-based acid is selected from fuming sulfuric acid and chlorosulfonic acid.

18. The product made by the process of claim 1.

19. A product comprising a fluoropolymer surface having a rough texture and residues of treatment of the surface with a sulfur-based acid, wherein the surface exhibits hydrophilic properties.

20. A semiconductor material processing tool comprising a product of claim 19.
